(19) United States
(12) Patent Application Publication
(10) Pub. No.: US 2014/0149819 A1
(43) Pub. Date: May 29, 2014

(54) METHOD AND APPARATUS FOR PROTOCOL DATA UNIT RECOVERY IN AN IS-IS SYSTEM

(71) Applicant: TELEFONAKTIEBOLAGET L M ERICSSON (PUBL), (US)

(72) Inventors: Wenhu Lu, San Jose, CA (US); Thippanna Hongal, Fremont, CA (US); Ing-Wher Chen, McLean, VA (US)

(73) Assignee: TELEFONAKTIEBOLAGET L M ERICSSON (PUBL), Stockholm (SE)

(21) Appl. No.: 13/841,654

(22) Filed: Mar. 15, 2013

Related U.S. Application Data
(60) Provisional application No. 61/730,778, filed on Nov. 28, 2012.
(60) Provisional application No. 61/730,784, filed on Nov. 28, 2012.
(60) Provisional application No. 61/730,796, filed on Nov. 28, 2012.

(51) Int. Cl. H04L 1/18

(52) U.S. Cl. CPC H04L 1/1809
USPC 714/748

(57) ABSTRACT

A method and apparatus for effectuating LSP recovery in an IS-IS router. When a standby router processor (RP) module of the IS-IS router is activated, at least one CSNP packet is generated by the newly activated RP module based on its link state database. The CSNP packet is then transmitted on all point-to-point links and all broadcast links supported by the IS-IS router.

### PRIORITY UNDER 35 U.S.C. §119(e) & 37 C.F.R. §1.78

This nonprovisional application claims priority based upon the following prior United States provisional patent applications entitled: (i) “IS-IS NON STOP ROUTING COMPLETE SEQUENCE NUMBER PROTOCOL (CSNP) DATA UNIT FOR LINK-STATE PROTOCOL (LSP) DATA UNIT RECOVERY AND GRACEFUL RESTART,” Application No. 61/730,778, filed Nov. 28, 2012, in the name(s) of Wenhu Lu, Thippana Hongal and Ing-Wher Chen; (ii) “IS-IS NON-STOP ROUTING (NSR) RAW LINK-STATE PROTOCOL (LSP) DATA UNIT SYNCHRONIZATION,” Application No. 61/730,784, filed Nov. 28, 2012, in the name(s) of Wenhu Lu, Ing-Wher Chen and Thippana Hongal; and (iii) “METHOD AND APPARATUS FOR NON-STOP ROUTING FOR PROCESS RESTART,” Application No. 61/730,796, filed Nov. 28, 2012, in the name(s) of Wenhu Lu, Ing-Wher Chen and Thippana Hongal; each of which is hereby incorporated by reference in its entirety.

### CROSS-REFERENCE TO RELATED APPLICATION(S)

This application discloses subject matter that is related to the subject matter of the following U.S. patent application(s): (i) “METHOD AND APPARATUS FOR PROTOCOL DATA UNIT SYNCHRONIZATION IN AN IS-IS SYSTEM” (Ericsson Ref. No.: P38851-US2), application Ser. No. ______, filed ______, in the name(s) of Wenhu Lu, Ing-Wher Chen and Thippana Hongal; (ii) “METHOD AND APPARATUS FOR FACILITATING PROCESS RESTART IN AN IS-IS SYSTEM” (Ericsson Ref. No.: P38916-US2), application Ser. No. ______, filed ______, in the name(s) of Wenhu Lu, Ing-Wher Chen and Thippana Hongal; and (iii) “METHOD AND APPARATUS FOR FACILITATING PROCESS RESTART IN A MULTI-INSTANCE IS-IS SYSTEM” (Ericsson Ref. No.: P40160-US1), application Ser. No. ______, filed ______, in the name(s) of Wenhu Lu, Ing-Wher Chen and Thippana Hongal; each of which is hereby incorporated by reference in its entirety.

### FIELD OF THE DISCLOSURE

The present disclosure generally relates to network routing protocol technologies. More particularly, and not by way of any limitation, the present disclosure is directed to a method and apparatus for protocol data unit recovery in an Intermediate System-Intermediate System (IS-IS) router deployed in an IS-IS routing network.

### BACKGROUND

An IS-IS router generates link state protocol data units (LSPs) to describe the routers and links to which it is connected. The information regarding the connected routers and links may be received from other modules in the router, such as physical ports.

Typically, a standby router module and an active router module may be provided as part of the IS-IS router in order to facilitate the capability referred to as Non Stop Routing (NSR). To support NSR capability, databases used for routing must be synchronized between the standby and active router modules so that when the standby router module becomes active, it has a complete database to function seamlessly.

### BRIEF DESCRIPTION OF THE DRAWINGS

Embodiments of the present disclosure are illustrated by way of example, and not by way of limitation, in the Figures of the accompanying drawings in which like references indicate similar elements. It should be noted that different references to “an” or “one” embodiment in this disclosure are not necessarily to the same embodiment, and such references may mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

The accompanying drawings are incorporated into and form a part of the specification to illustrate one or more exemplary embodiments of the present disclosure. Various advantages and features of the disclosure will be understood from the following Detailed Description taken in connection with the appended claims and with reference to the attached drawing Figures in which:

FIG. 1 depicts an example IS-IS network environment or domain wherein one or more embodiments of the present patent disclosure may be practiced;

FIG. 2 depicts a block diagram of an IS-IS router system according to an embodiment of the present patent disclosure;

FIG. 3 depicts a block diagram of a simplified version of an IS-IS router that implements a protocol data unit recovery mechanism according one embodiment; and

FIGS. 4A-4C depict flowcharts of one or more embodiments pertaining to sequences of events that may occur according to a protocol data unit recovery mechanism of the present patent disclosure.

### DETAILED DESCRIPTION OF THE DRAWINGS

The present patent disclosure is broadly directed to a method and apparatus for recovering LSPs in an IS-IS router that is undergoing a failover or switchover for purposes of effectuating Non Stop Routing. The present patent disclosure is also directed to associated computer-accessible media, computer programmable products and various software/firmware components relative to the LSP recovery techniques set forth herein.

In one aspect, an embodiment of a method performed in a network element operating as an IS-IS router is disclosed, wherein the IS-IS router may comprise an active route processor (RP) module and a standby route processor (RP) module. The claimed embodiment comprises activating the standby RP module to become a new active RP module; generating at least one Complete Sequence Numbers Protocol Data Unit (CSNP) packet based on information maintained in a link state database associated with the new active RP module; and transmitting the at least one CSNP packet by the new active RP module on all point-to-point links and all broadcast links identified in an adjacency database of the network element. In another aspect, an embodiment of a non-transitory computer-readable medium containing instructions stored thereon is disclosed. When the stored instructions are executed by a computer system configured to operate as an IS-IS router, the computer system is operable to perform an embodiment of the method set forth above.

In a still further aspect, an embodiment of a network element configured to operate as an IS-IS router is disclosed. The claimed embodiment comprises an active RP module associated with an IS-IS routing process based on a first link state database as well as a standby RP module associated with a second link state database. A non-stop routing (NSR) module is operatively coupled to the active and standby RP modules, wherein the NSR module is configured to facilitate, responsive to activating the standby RP module to become a new active RP module (e.g., upon a failure of the active RP module or responsive to some other control signal), generation of at least one CSNP packet based on information maintained in the second link state database and transmission of the at least one CSNP packet by the new active RP module on all point-to-point links and all broadcast links identified in an adjacency database of the network element.

In the following description, numerous specific details are set forth with respect to one or more embodiments of the present patent disclosure. However, it should be understood that one or more embodiments may be practiced without such specific details. In other instances, well-known circuits, subsystems, components, structures and techniques have not been shown in detail in order not to obscure the understanding of the example embodiments. Accordingly, it will be appreciated by one skilled in the art that the embodiments of the present disclosure may be practiced without such specific details. It should be further recognized that those of ordinary skill in the art, with the aid of the Detailed Description set forth herein and taking reference to the accompanying drawings, will be able to make and use one or more embodiments without undue experimentation.

Additionally, terms such as “coupled” and “connected,” along with their derivatives, may be used in the following description, claims, or both. It should be understood that these terms are not necessarily intended as synonyms for each other. “Coupled” may be used to indicate that two or more elements, which may or may not be in direct physical or electrical contact with each other, co-operate or interact with each other. “Connected” may be used to indicate the establishment of communication, i.e., a communicative relationship, between two or more elements that are coupled with each other. Further, in one or more example embodiments set forth herein, generally speaking, an element, component or module may be configured to perform a function if the element is capable of performing or otherwise structurally arranged to perform that function.

As used herein, a network element (e.g., a router, switch, bridge, etc.) is a piece of networking equipment, including hardware and software that communicatively interconnects other equipment on a network (e.g., other network elements, end stations, etc.). Some network elements may comprise “multiple services network elements” that provide support for multiple networking functions (e.g., routing, bridging, switching, Layer-2 aggregation, session border control, Quality of Service, and/or subscriber management, and the like), and/or provide support for multiple application services (e.g., data, voice, and video). Subscriber end stations (e.g., servers, workstations, laptops, netbooks, palm tops, mobile phones, smartphones, multimedia phones, Voice Over Internet Protocol (VoIP) phones, user equipment, terminals, portable media players, GPS units, gaming systems, set-top boxes) may access or consume content/services provided over a packet-switched wide area public network such as the Internet via suitable service provider access networks. Subscriber end stations may also access or consume content/services provided on virtual private networks (VPNs) overlaid on (e.g., tunneled through) the Internet. It should be appreciated that one or more embodiments of the present patent disclosure involving IS-IS routing protocol functionality may be implemented in such arrangements wherein the content and/or services are typically provided by one or more end stations (e.g., server end stations) belonging to a service or content provider. Alternatively or additionally, content and/or services may be consumed among the end stations participating in a peer-to-peer service, and may include, for example, public webpages (e.g., free content, online store fronts, search services, etc.), private webpages (e.g., username/password accessed webpages providing email services), and/or corporate networks over VPNs. Typically, subscriber end stations may be coupled (e.g., through customer premise equipment or CPE coupled to an access network (wired or wirelessly)) to edge network elements, which are coupled (e.g., through one or more core network elements) to other edge network elements, which are coupled to other end stations (e.g., server end stations).

One or more embodiments of the present patent disclosure may be implemented using different combinations of software, firmware, and/or hardware. Thus, one or more of the techniques shown in the Figures (e.g., flowcharts) may be implemented using code and data stored and executed on one or more electronic devices (e.g., an end station, a network element, etc.). Such electronic devices may store and communicate (internally and/or with other electronic devices over a network) code and data using computer-readable media, such as non-transitory computer-readable storage media (e.g., magnetic disks, optical disks, random access memory, read-only memory, flash memory devices, phase-change memory, etc.), transitory computer-readable transmission media (e.g., electrical, optical, acoustical or other form of propagated signals—such as carrier waves, infrared signals, digital signals), etc. In addition, such electronic devices may typically include a set of one or more processors coupled to one or more other components, such as one or more storage devices (non-transitory machine-readable storage media), user input/output devices (e.g., a keyboard, a touch screen, a pointing device, and/or a display), and network connections. The coupling of the set of processors and other components may be typically through one or more buses and bridges (also termed as bus controllers), arranged in any known (e.g., symmetric/shared multiprocessing) or heretofore unknown architectures. Thus, the storage device or component of a given electronic device may be configured to store code and/or data for execution on one or more processors of that electronic device for purposes of implementing one or more techniques of the present disclosure.

By way of example, embodiments of the present patent disclosure will be described below in detail by taking reference to a router network based on the Intermediate System-to-Intermediate System (IS-IS) routing protocol. IS-IS routing protocol, which is standardized according to the ISO/IEC 10589 specification, incorporated by reference herein, is a link-state protocol similar to Open Shortest Path First (OSPF) routing protocol. As is known, a link-state routing protocol is one of the two main classes of routing protocols used in packet-switching networks for communications, the other being the distance-vector routing protocol. Both OSPF and IS-IS are examples of an Interior Gateway Protocol (IGP) that may be used for routing information within a domain or autonomous system (AS). In contrast, an Exterior Gateway Protocol (EGP) may be used for determining network reachability between autonomous systems and makes use of IGPs to resolve routes within an AS.

In a link-state routing protocol based network, each switching node (i.e., nodes or elements that are configured to forward packets, also known as routers) constructs a map of the connectivity of the network, in the form of a graph, showing which nodes are connected to which other nodes. Each node then independently calculates the best paths from that node to every possible destination in the network (e.g., using Dijkstra's algorithm), the collection of which forms the node's routing table or database.

To achieve scalability as well as simplify router design and operation, a hierarchical routing architecture may be utilized in a routing network. For example, a domain or AS—which is a portion of the network that may be under a common administrative authority—may be organized such that one or more areas may be defined within the domain or AS. In general, an area may be a logical entity that is comprised of a set of contiguous routers and the data links that connect them. All routers in the same area exchange information about all the hosts or End Systems (ESs) they can reach. The areas of an AS or domain are connected to form a backbone, wherein the routers have the information how to reach all areas.

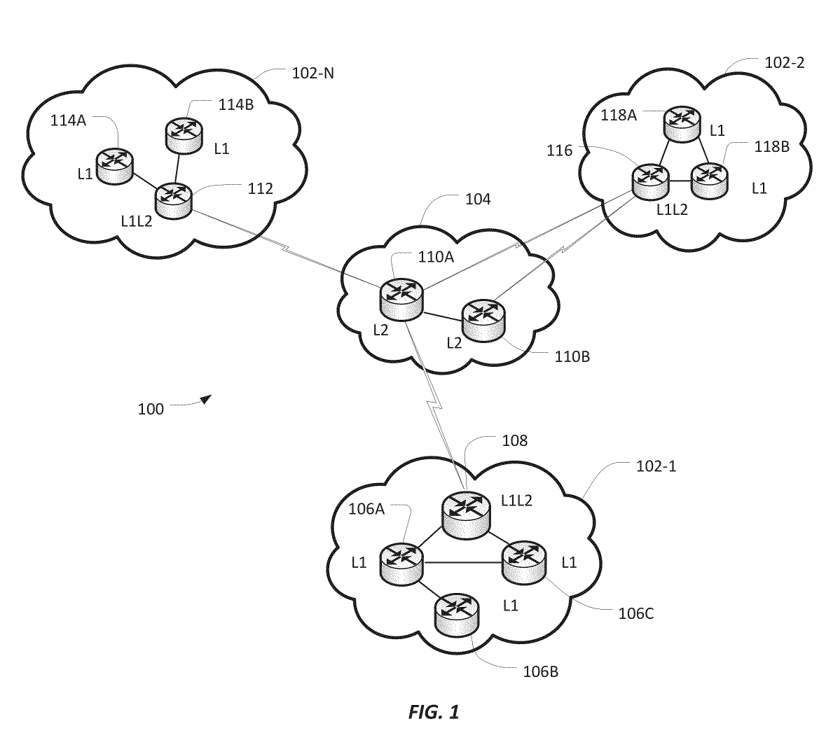

Routers that can communicate within the same area are designated as Level 1 (L1) routers. Routers that form the backbone and have the information to reach other areas are designated as Level 2 (L2) routers. Some routers may be configured to operate as both L1 and L2 routers (L1L2) and may therefore be provided with routing databases specific to both intra-area and inter-area routing. Referring now to the drawings and more particularly to FIG. 1, depicted therein is an example IS-IS network environment or domain 100 comprising a plurality of areas 102-1 to 102-N that are coupled to a backbone 104, wherein an IS-IS router (or, simply an IS router) may be advantageously implemented according to one or more embodiments of the present patent disclosure. By way of illustration, the backbone 104 is comprised of two L2 routers 110A and 110B that are interconnected. Each area is coupled to the backbone 104 via a single L1L2 router within the area. For instance, area 102-1 includes three L1 routers 106A-106C and an L1L2 router 108 that is connected to L2 router 110A of the backbone 104. In similar fashion, area 102-2 includes two L1 routers 118A-118B and an L1L2 router 116 that is connected to both L2 router 110A and L2 router 110B, and area 102-N includes two L1 routers 114A-114B and an L1L2 router 112 that is connected to L2 router 110A.

For purposes of effectuating an operative routing network, each of the IS-IS routers engages in appropriate data exchange processes and maintains a number of databases that can be arranged in any known or heretofore unknown architectures. A unit of data, defined as a protocol data unit (PDU), may be regarded as a packet that is used for exchange of data. Four general types of packets exist, depending on the function of the PDU. A Link State Protocol Data Unit (LSP) is used for distributing link state information relative to the physical links (e.g., broadcast or point-to-point links) supported by the routers of the network. An IS-IS Hello (IIH) PDU is used for establishing and maintaining neighbor relationships (i.e., adjacencies) among the routers of the network, wherein an adjacency refers to a relationship between two IS-IS routers if they can perform a two-way communication with each other. Special PDUs known as Sequence Number PDUs (SNPs) may be used for purposes of link state database synchronization among the IS-IS routers. A Partial Sequence Number PDU (PSNP) is used to acknowledge and request link state information among the routers. A Complete Sequence Number PDU (CSNP) is used to describe a router's complete link state database. Depending on the size of a link state database associated with an IS-IS router, more than one CSNP may be needed to transmit the entire contents of the link state database in certain implementations.

Because of the hierarchical routing architecture of an IS-IS network, such as the network 100 exemplified in FIG. 1, each of the foregoing packets or PDUs can be designated as Level 1 or Level 2 packets and may be used by a router of a particular level for purposes of exchanging data and populating suitable routing databases. A Level 1 (L1) router (e.g., L1 106A in area 102-1) knows the topology of its own area (i.e., it has neighbors only within the same area) and therefore maintains Level 1 databases (e.g., one or more Level 1 link state databases and one or more Level 1 forwarding databases), collectively comprising a routing information database, as well as a Level 1 adjacency database for effectuating intra-area routing. An L1 router may have both L1 and L1/L2 neighbors in its area, however. In similar fashion, a Level 2 (L2) router (e.g., L2 110A) may have neighbors in the same area or other areas and maintains Level 2 databases for effectuating inter-area routing. An L1L2 router (e.g., L1L2 108), on the other hand, maintains separate Level 1 databases (for intra-area routing) as well as Level 2 databases (for inter-area routing).

After the IIH PDUs are exchanged and adjacencies are established in the IS-IS network, LSPs may be transmitted by the routers on all known links or interfaces (i.e., flooding) to exchange network topology information. In general, LSPs have a fixed header and one or more variable length content fields that are encoded using Type, Length and Value (TLV) coding. The fixed header may contain the PDU type/length, the LSP ID and sequence number, checksum, hierarchical level of the LSP (i.e., L1 or L2), among others. The TLV-coded contents may comprise the issuing IS router's area addresses, neighbor IS routers, neighbor ES routers, authentication information, etc. Because both point-to-point and broadcast links (or, synonymously, circuits or interfaces) may be supported in an IS-IS network, two types of LSP flooding may occur. On a point-to-point link or circuit, when the adjacency is established between two IS-IS routers, each router sends a CSNP packet (a summary of the sending router's database) to the other router. Any missing LSPs may be sent by both sending and receiving routers if such LSPs were not present in the received CSNP and missing LSPs may only be requested through a PSNP packet. Accordingly, in a typical implementation of a point-to-point circuit or path, the CSNP packet may be sent only once, at the initiation of the circuit when an adjacency between two connected IS-IS routers is being established. Upon receiving a CSNP packet, a receiving router sends to the sending router the LSPs that are in the receiving router's database but which were not summarized in the CSNP from the sending router. Additionally, the receiving router requests for the LSPs not in its own database but which exist in the received CSNP, which CSNP reflects the sending router's database. To ensure that the two routers' databases can become synchronized, the IS-IS specification also requires that the router that requests an LSP replies to the sender with an acknowledgment. If the sender does not receive an acknowledgment for the LSP that was previously sent, the sender is required to retransmit the requested LSP until an acknowledgment is received. In other words, on a point-to-point link, the initial, single CSNP is used to initiate database exchange procedures, but a different mechanism is used for subsequent LSP exchanges.

Broadcast circuits, such as, e.g., Ethernet, Token Ring, and Fiber Distributed Data Interface (FDDI), are multi-access in that they support addresses referring to groups of attached systems and are therefore able to connect to more than two devices, wherein all connected routers can receive a packet sent by one router. In a broadcast IS-IS circuit, one IS router may be designated or otherwise elected to be a Designated IS (DIS) router, which assumes the responsibility for flooding the packets to a pseudonode representing the local area network (LAN). According to one arrangement, a DIS router may be configured to multicast a CSNP periodically so that all routers in the LAN may check the received CSNP against their respective link state databases and may request specific retransmissions via PSNP packets.

To support enhanced functionalities such as Non Stop Routing (NSR), Stateful Switch Over (SSO), In-Service Software Upgrades (ISSU), and the like, any of the IS-IS routers exemplified in the IS-IS network 100 of FIG. 1 may be architected with redundancy, e.g., using separate processing hardware platforms or modules (each having one or more processors and associated memory coupled thereto in a suitable bus architecture), whereby an IS-IS routing process involving generation and propagation of the link state information and computation of routes using the link state information (i.e., the control plane) can be provisioned to be executed on the separate hardware platforms. It should be recognized that in some implementations, the individual hardware platforms may be co-located or otherwise integrated into a network element or node. In other implementations, the hardware platforms may be provided as distributed equipment that logically functions as a single network node. Regardless of any specific implementation, when a redundancy architecture having multiple instances of the IS-IS routing process is utilized for an IS router implementation, typically only one of the instances of the IS-IS process executing on the associated hardware platform may be active at any one time, the remaining instances and corresponding hardware platforms being “inactive” or “dormant” (i.e., in a standby mode). Furthermore, the router databases may also be redundantly provisioned or at least logically partitioned such that each standby instance of the IS-IS routing process has a separate database copy associated therewith, which is updated or synchronized based on the database(s) associated with the active IS-IS routing process that typically maintains the most up-to-date or accurate contents (e.g., link state information, forwarding data, adjacency data, etc.).

It should be appreciated that in order to support enhanced functionality such as, e.g., NSR, SSO, etc., the database(s) of a standby IS-IS hardware platform (which may be referred to as a route processor (RP) module) associated with an inactive IS-IS routing process must be maintained as current as possible relative to the database(s) of the active RP module executing the active IS-IS routing process, should it be necessary for any reason that the active IS-IS routing process cease its control plane execution and an inactive IS-IS routing process on the standby RP module take over the control. For example, to provide Non Stop Routing in a failover or in an operator-induced switchover scenario, the link state database of the active RP module (or, more generally an active router) must be accurately synchronized to the database(s) of the standby RP module (or, more generally a standby router) so that when the standby IS-IS router becomes the active IS-IS router, the active IS-IS router has a complete database to function seamlessly.

Those skilled in the art will recognize upon reference hereto that an IS-IS router architected with redundancy may be deployed to include a system of two or more RP modules, at least one of which is in an active mode and the remaining being in a standby mode. Accordingly, references to an “active IS-IS router” may mean an active RP module and references to a “standby IS-IS router” may mean a standby RP module in certain embodiments for purposes of the present patent disclosure.

Regardless of the approach used to synchronize the link state database(s), it is always possible that the existing active IS-IS router or RP module could become inoperative during synchronization. If this occurs, the new active IS-IS router or RP module might not have received data for each and every portion of the database, for example, an update of a neighbor's LSPs or new LSPs from a router in the domain. Further, when the control plane is being transitioned from the current active RP module to a standby RP module (which then becomes the new active RP module) of an IS-IS router, it is desirable that the transitioning be transparent to the rest of the IS-IS network so that there is minimal disruption in the routing process.

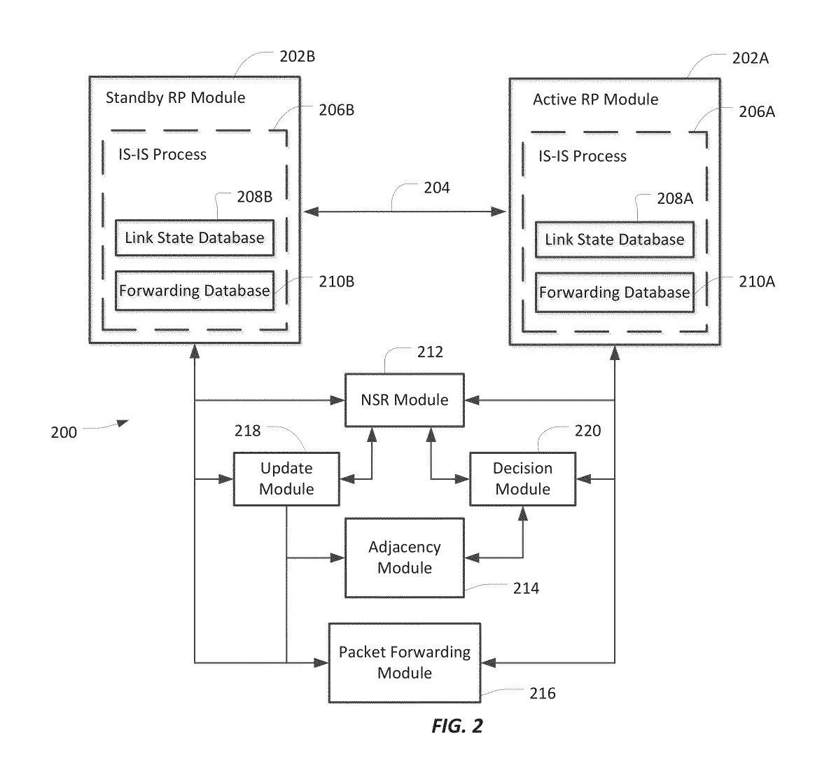

Taking reference to FIG. 2, depicted therein is a logical block diagram of a network element 200 operating as an IS-IS router having redundancy wherein missing LSPs may be recovered in the event of a failover or a switchover according to an embodiment of the present patent disclosure. It should be apparent that the network element 200 may be configured to function as a physical router system in an L1, L2 or L1/L2 hierarchy according to the IS-IS specification, and may illustrate a particular implementation of any of the IS-IS routers of the network 100 of FIG. 1 described hereinabove. By way of example, a single active RP module 202A (which may form a computer platform or a portion thereof) supporting an active IS-IS routing process instance 206A and a single standby RP module (which may form another computer platform or a portion thereof) 202B supporting an inactive IS-IS routing process instance 206B are provided as part of the network element 200. Associated with the existing or current active IS-IS routing process 206A are the active routing databases, e.g., a first link state database 208A and a first forwarding database 210A. In similar fashion, the existing or current inactive IS-IS routing process 206B is supported by its databases, e.g., a second link state database 208B and a second forwarding database 210B. An inter-process communication path 204 may be mediated by means of a suitable structural and/or functional module for effectuating inter-process communications including, e.g., data synchronization between the two sets of databases. Conforming with the IS-IS specification, an Update module 218 and a Decision module 220 are provided, which may be in communicative relationship with the active and standby RP modules 202A and 202B such that appropriate database updating and decision processes can continue to take place regardless of a failover or a switchover. An Adjacency module 214 is illustrative of one or more adjacency databases populated with router adjacency information that may be partitioned between the active and standby RP modules 202A and 202B. A Packet Forwarding module 216 may be provided that is responsible for forwarding IS-IS control packets. Those skilled in the art will recognize that although single modules are exemplified in FIG. 2, (i.e., Update module 218, Decision module 220, Adjacency module 214 and Packet Forwarding module 216), the functionality of such modules may be redundantly provided in another implementation, i.e., a separate module/process may be provided for each of the active RP and standby RP platforms.

To facilitate NSR and LSP recovery according to the teachings of the present patent disclosure, an NSR module 212 may be provided such that NSR and related functionalities set forth in additional detail below can be grouped into a logical block that may comprise suitable hardware and/or software including storage media having computer-executable instructions. In one example implementation, the NSR module 212 may be configured to facilitate the execution of one or more of the following acts: activating the standby RP module 202B to become a new active RP module; generating at least one CSNP packet based on information maintained in the link state database 208B associated with the new active RP module 202B; and transmitting the at least one CSNP packet by the new active RP module 202B on all point-to-point links and all broadcast links identified in the adjacency database 214 of the network element 200. It should be apparent that the term “links” may broadly be used synonymously with “circuits,” “ports,” “paths,” “interfaces”, and the like, for purposes of the present patent disclosure.

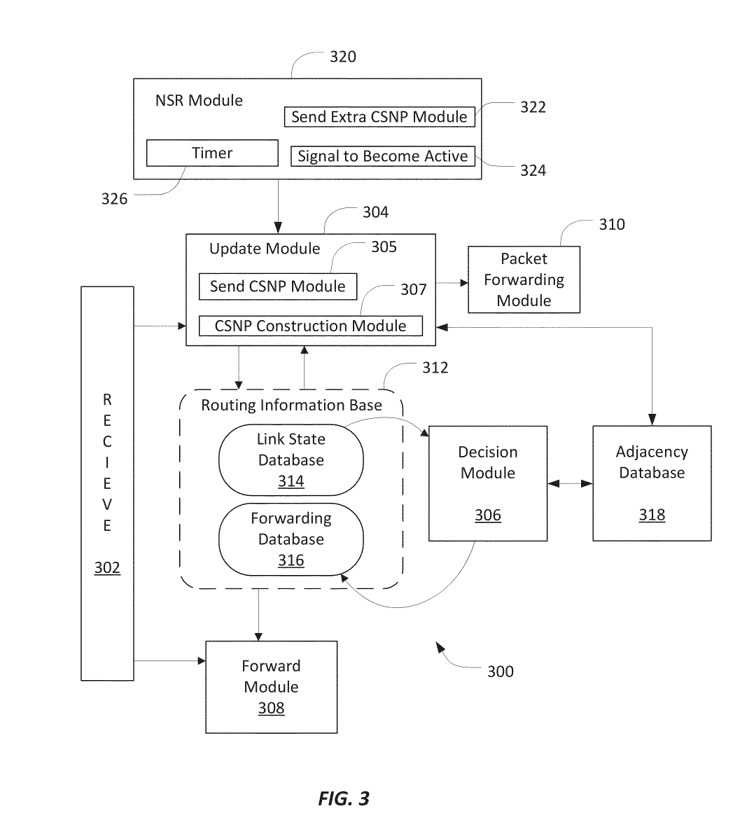

FIG. 3 depicts a block diagram of an IS-IS router embodiment 300 that is illustrative of a simplified version of the network element 200 described above but includes additional detail with respect to a single RP module as it is activated to become a new active RP module and implement an LSP recovery mechanism according to the teachings set forth herein. The overall functionality of the IS-IS router module 300 may be advantageously described in terms of certain subnetwork independent processes or process modules that conform to the IS-IS specification, but augmented with an NSR functionality and LSP recovery module for purposes of the present patent disclosure. As illustrated in FIG. 3, the various process modules include a Receive process or module 302, an Update process or module 304, a Decision process module 306 and a Forward process or module 308. Broadly, the Update and Decision process modules 304, 306 may be categorized as routing functionality components whereas the Receive and Forwarding process modules 302, 308 may be categorized as information collection and distribution components of the IS-IS router embodiment 300. Depending on whether the IS-IS router 300 is at Level 1, Level 2, or both, each of the foregoing processes may be implemented and maintained as a Level 1 or Level 2 process. Similarly, a number of databases may also be provisioned and maintained as Level 1 or Level 2 databases as alluded to previously. In general, these databases may comprise a Routing Information Base (RIB) 312 including a Link State Database 314 and a Forwarding Database 316 and an Adjacency Database 318, which support the Decision process module 306.

The Receive process module 302 may obtain its inputs from a number of sources (e.g., received PDUs, routing information derived by the ES-IS protocol, etc.) and may perform appropriate actions thereon, which may involve passing the PDUs to some other function or process. For instance, if the received PDU is an LSP or SNP, the PDUs may be passed to the Update process 304. If the received PDU is an IIH PDU, it may be passed to a suitable subnetwork dependent function. If the received PDU is a data network PDU (NPDU) or an error report for another destination, such information is propagated to the Forwarding process 308.

The Update process module 304 is responsible for generating and propagating Link State information reliably throughout the routing domain in which the IS-IS router embodiment 300 may be deployed. As such, the Update process 304 may be configured to construct, receive and propagate LSPs that contain information about the identity and routing metric values of the adjacencies of the IS-IS router that originated the LSPs. When the Update process 304 receives LSPs and SNPs from the Receive process 302, it is configured to place new routing information in RIB 312 as well as propagate it to other IS-IS routers using a subnetwork dependent Packet Forwarding process 310. Additionally, the Update process module 304 may use the contents of the adjacency database 318 as well as any notifications of adjacency changes (e.g., an adjacency has come up, gone down, or changed cost, etc.) to provide suitable updates to the Link State Database 314.

The Decision process module 306 uses the contents of Link State Database 314 to calculate the Forwarding database(s) 316, from which the Forwarding process 308 can determine the proper next hop for each NPDU. Although not separately shown in FIG. 3, it should be recognized that a Level 1 Link State Database is used for calculating the Level 1 Forwarding Database(s) whereas a Level 2 Link State Database is used for calculating the Level 2 Forwarding Database(s).

An NSR module 320 for facilitating NSR capability and LSP recovery may be implemented as a separate logical functional process or block to effectuate seamless transitioning of the control plane as well as achieve faster database convergence when a failover or switchover condition is encountered. When a Signal to Become Active module 324 is activated, the RP module of IS-IS router 300 is configured to transition from a standby or inactive state to become active, whereupon a Send Extra CSNP module 322 of the NSR module 320 may be triggered in order to force one or more CSNPs to be constructed based on the contents of the Link State Database 314 for transmission on all links or circuits supported by the IS-IS router 300. Accordingly, responsive to the Send Extra CSNP module 322, a CSNP Construction module 307 associated with the Update process module 304 may be activated for building one or more CSNP packets (i.e., at least one CSNP) depending on the size of the contents of the Link State Database(s) 314. It should be recognized that the contents of the Link State Database(s) 314 may only be as current as the most recent synchronization with an active Link State Database associated with the former active RP module of the router that experienced or encountered a failover or switchover condition. Further, the CSNP packet(s) may be Level 1, Level 2 or both, based on the hierarchical level of the IS-IS router 300.

Once the CSNP packet(s) are constructed, a Send CSNP module 305 that may be associated with the Update process module 304 may be alerted to perform the necessary tasks such that the Packet Forwarding module 310 may transmit the CSNP packet(s) on all point-to-point and broadcast links/circuits based on the adjacencies supported by the IS-IS router 300. In one implementation, such a transmission of the CSNP packet(s) may be effectuated unconditionally and may be mediated by the use of a timer mechanism 326 associated with each link/circuit. One skilled in the art will recognize that the timer mechanism 326 may be utilized in order that the forced or jump-started transmission of the CSNP(s) is performed somewhat orderly and potentially/optionally upon expiration of a “settling period” during which any transient conditions experienced by the IS-IS router 300 during a failover scenario have been mitigated. Once the forced transmission of CSNP packet(s) is effectuated, all neighboring routers of the domain are configured to send appropriate reply messages including any LSPs not summarized in the received CSNP packet(s). In one example implementation, suitable PSNP messages may also be exchanged subsequent to the forced transmission of the CSNP packet(s) if any additional LSPs are still missing and/or the database convergence is not entirely complete among the routers including the IS-IS router 300.

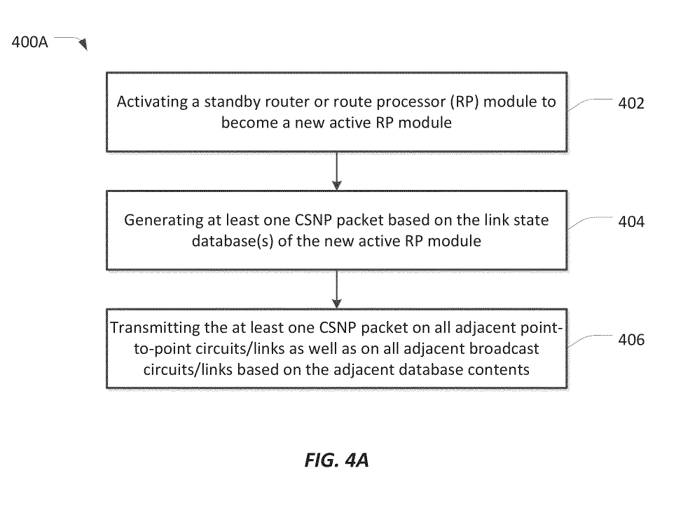

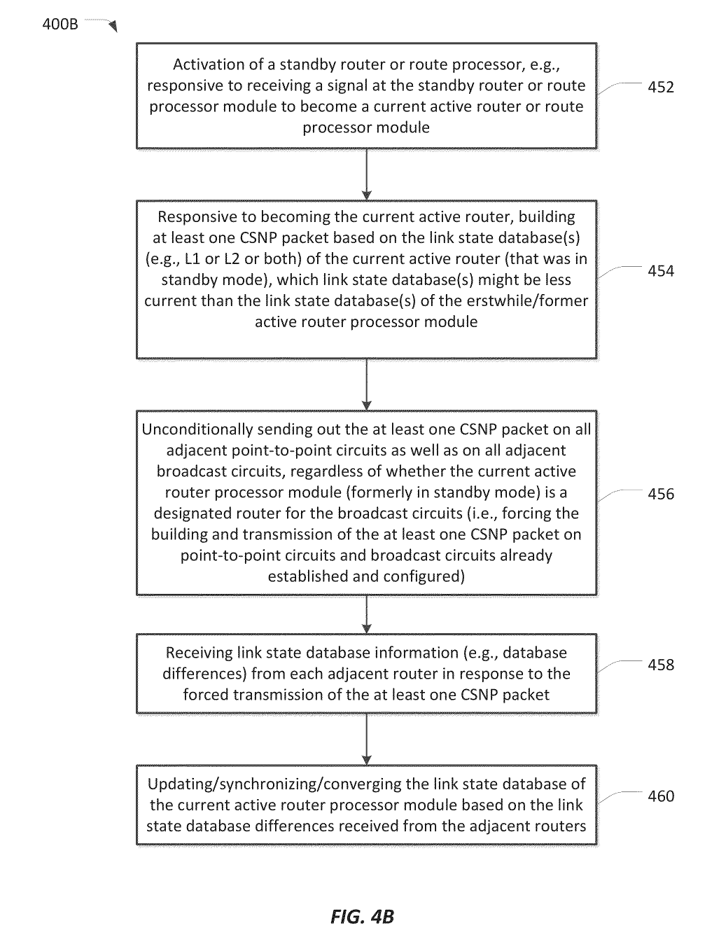

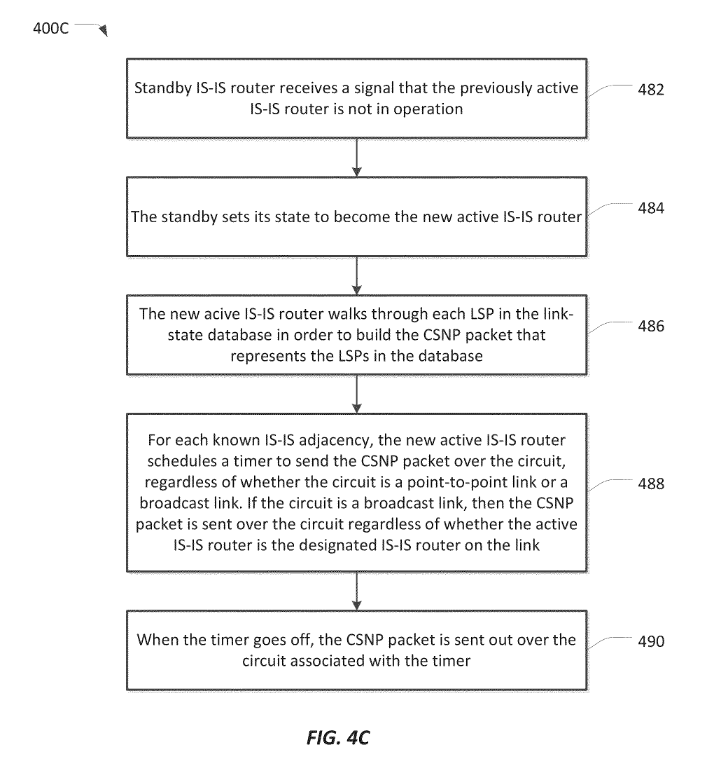

FIGS. 4A-4C depict flowcharts of one or more embodiments pertaining to sequences of events that may occur pursuant to an LSP recovery mechanism of the present patent disclosure in order to facilitate seamless NSR functionality. Additionally, as will be explained below, the features of the present embodiments may also advantageously impart and facilitate the functionality of a “Graceful Restart (GR) helper” with respect to an IS-IS router implemented according to the teachings of the present patent disclosure. One skilled in the art should appreciate that the order or sequence of the acts, steps, functions, components or blocks illustrated in any of the flowcharts depicted in FIGS. 4A-4C may be modified, altered, replaced, customized or otherwise rearranged within a particular flowchart, including deletion or omission of a particular act, step, function, component or block. Moreover, the acts, steps, functions, components or blocks illustrated in a particular flowchart may be inter-mixed or otherwise inter-arranged with the acts, steps, functions, components or blocks illustrated in another flowchart in order to effectuate additional variations, modifications and configurations with respect to one or more LSP recovery implementations for purposes of practicing the teachings of the present patent disclosure.

Referring in particular to FIG. 4A, a process 400A is illustrative of an embodiment of the overall functionality of a Layer-3 network element configured to operate as an IS-IS router system having an active RP module and a standby RP module wherein the standby RP module may be activated (block 402) to become the new active RP module. In one implementation, the standby RP module may be dormant until it is activated to become the new active RP module upon detecting a failure of the existing active RP module, which may comprise a hardware failure, a software failure, a firmware failure, or any combination thereof. In another implementation, the standby RP module may be activated to become the new active RP module based on a control signal configured to transition the existing active RP module into a standby or inactive mode. Irrespective of any specific implementation, an NSR process/module provided with the network element according to teachings herein is operable, responsive to the standby RP module being activated, to generate at least one CSNP packet based on the information maintained in a link state database associated with the standby RP module that has become the new active RP module (block 404). Thereafter, the CSNP packet(s) may be transmitted on all point-to-point links and all broadcast links identified in an adjacency database of the network element, regardless of whether the network element with the new active RP module is a DIS router on a broadcast link or not.

FIG. 4B depicts another embodiment 400B that illustrates additional acts, steps, functions, components or blocks that may be augmented within one or more variations of the process 400A described above. Blocks 452 and 454 comprise functionalities that are roughly similar to the functionalities set forth at blocks 402 and 404 described above, although block 454 specifically includes additional features relating to a CSNP being prepared based on Level-specific link state databases (i.e., L1, L2 or both) of the newly current active router or RP module, and the condition that link state databases of the newly current active router or RP module may be somewhat less current (and hence less complete) than the databases of the erstwhile/former active router or RP module. At block 456, one or more CSNP packets are unconditionally transmitted to all adjacent point-to-point links/circuits and all adjacent broadcast links/circuits, regardless of whether the IS-IS router is a designated router for the broadcast links/circuits. At block 458, various pieces of link state database information (e.g., database differences in terms of missing LSPs in the link state database of the newly current active router or RP module) are received from the adjacent routers, which information may then be used for updating or otherwise synchronizing the link state database of the newly current active router or RP module (block 460). Additionally, because the link state database of the newly current active RP module is updated independently (i.e., without the normal inter-process synchronization between the former active and newly current active platforms), one variation may involve inhibiting or otherwise suppressing LSP synchronization during a switchover scenario as well as in certain special cases such as synchronizing “jumbo” LSPs as will be described below.

A still further embodiment 400C is depicted in the flowchart of FIG. 4C that illustrates additional features that may be augmented within one or more variations of the processes described above, wherein blocks 482, 484 and 486 comprise functionalities that are roughly similar to the functionalities set forth at blocks 402 and 404 in FIG. 4A and blocks 452 and 454 in FIG. 4B. At block 488, a timer may be scheduled for each known adjacency as to when a CSNP packet may be sent out on that circuit, regardless of whether the circuit is a point-to-point link or a broadcast link. When the timer goes off, the CSNP packet(s) may be sent out over the circuit associated with the timer (block 490). As discussed previously, one or more timers may be created or configured on a link by link basis, wherein each timer value may be provisioned to be the same or identical for each one of the point-to-point links and broadcast links identified in the adjacency database of the IS-IS router. In other implementations, the timer values may be configured to be different (e.g., the timer value for at least one of the known adjacent links is configured to be a value different from the timer values associated with other links).

Those skilled in the art should appreciate that the embodiments of the present patent disclosure advantageously provide a mechanism to ensure that a new active IS-IS router or RP module's database can be completely synchronized with the other IS-IS routers in a network domain within a reasonable time. Because LSPs might be lost or missing during a switchover/failover when the standby RP module is gaining control of the control plane from the active RP module, the embodiments set forth herein provide that extra CSNP(s) be sent out by the new active RP module of the IS-IS router performing NSR over all known links to initiate database exchange procedures again, as if the adjacency is being established anew, whereby an accelerated convergence rate may be achieved. Additionally, because the new active IS-IS router or RP module can initiate, at will, database exchange procedures using normal protocol processing, the messaging between the old active and the standby IS-IS router modules do not need to be done reliably, which greatly reduces the complexity of the code and the amount of messages required otherwise between the active and the standby RP modules via inter-process synchronization communication.

An additional advantage to having the new active RP module of the IS-IS router initiate database exchange procedures at will is that certain LSPs, such as jumbo LSPs, do not need to be synchronized from the old active database(s) to the database(s) of the newly activated RP module of the IS-IS router. Not sending jumbo LSPs between the erstwhile/former active platform and the new active platform (which was in the standby mode) makes coding simpler, because of the lack of special cases. A typical system that can perform NSR and that is to have the ability to handle jumbo LSPs will require synchronization of jumbo LSPs. However, inter-process communication libraries/software that provide the underlying synchronization services generally do not communicate using message sizes as large as jumbo LSPs, which can be over 9000 bytes in some instances. As a result, a special communication library might need to be built specifically to synchronize jumbo LSPs in a conventional IS-IS router implementation. In contrast, by sending the extra CSNP packet(s) in accordance with the teachings of the present patent disclosure, even if jumbo LSPs had not been synchronized to the new active platform, the IS-IS router can recover jumbo LSPs through database exchange procedures initiated by the new active RP module of the IS-IS router. In other words, the extra CSNP(s) sent by the new active RP platform is an alternative way for the IS-IS router to obtain jumbo LSPs, eliminating the need to synchronize jumbo LSPs altogether and thus obviating the need for building special inter-process communication software to synchronize jumbo LSPs.

Another—and unexpected—advantage of having the new active RP module of the IS-IS router unconditionally send out a CSNP packet over all circuits is that the IS-IS router can immediately act as the “helper” of a restarting router performing a GR procedure without additional effort. Normally, when an IS-IS router is restarted for whatever reason, temporary disruption of routing occurs due to events in both the restarting router and the neighbors of the restarting router. The router that has been restarted computes its own routes before achieving database synchronization with its neighbors. The results of such computation are likely to be non-convergent with the routes computed by other routers in the area/domain. Neighbors of the restarting router detect the restart event and cycle their adjacencies with the restarting router through the down state. The cycling of the adjacency state causes the neighbors to regenerate their LSPs describing the adjacency concerned. This in turn may cause a temporary disruption of routes passing through the restarting router. In certain scenarios, the temporary disruption of the routes can be highly undesirable. RFC 5306, incorporated by reference herein, sets forth mechanisms to avoid or minimize the disruption, and describes the signaling between a restarting IS-IS router that wishes to perform GR and its neighbors, some of which may be capable of being GR helpers. Table 1 below illustrates an example sequence of events and actions performed as a GR helper based on RFC 5306 and in accordance with the teachings of the present patent application.

TABLE 1

| | | ADJ Suppressed |
|---|---|---|
| | Running | (Action of NSR IS- |
| | (Action of NSR IS-IS | IS Router in ADJ |
| State/Event | Router in Running State) | Suppressed State) |
| Signal to become | Maintain ADJ State | |
| Active | Send CSNP | |
| (S1) | (A1) | |
| Receive IIH with | Maintain ADJ State | |
| RR | Send RA | |
| (S2) | Set SRM, send CSNP | |
| | (CSNPs are sent by | |
| | routers in accordance with | |
| | RFC Section 3.2.1c) | |
| | Update Hold Time, set | |
| | Restart Mode, if Restart | |
| | Mode clear | |
| | (A2) | |
| Receive IIH with | Clear Restart mode | |
| RR cleared | (A3) | |
| (S3) | | |
| Receive IIH with | Suppress IS neighbor | |
| SA | TLV in LSP(s) | |
| (S4) | Goto ADJ Suppressed | |
| | (A4) | |
| Receive IIH with | | Unsuppress |
| SA cleared | | IS neighbor |
| (S5) | | TLV in LSP(s) |
| | | Goto Running |
| | | (A5) |

When a restarting IS-IS router is to perform GR, the restarting router sends an IIH message with Restart Request (RR) flag set over its activated interfaces (S2). The IIH with RR is intended to signal to neighboring routers for help. The help that the restarting router needs is for the neighbor to continue to maintain the adjacency (i.e., not re-establish the adjacency) and also to send a CSNP packet so that database exchange procedures can begin (A2). A restarting router might subsequently send additional messages, including IIH with RR cleared (S3), IIH with Suppress Adjacency Advertisement (SA) (S4), and IIH with SA cleared (S5). These messages will result in a peer IS-IS router acting as the GR helper taking certain actions (A3), (A4) and (A5), respectively. However, the most important action taken by the GR helper is the act of maintaining the adjacency and sending the CSNP packet (A2).

For the new active IS-IS router performing NSR, responsive to a control signal to become active (S1), the embodiments of the present patent disclosure provide that maintaining the adjacency with the restarting router is the norm (A1). By sending the CSNP packet unconditionally (A1), the new active IS-IS router effectively fulfills the duties of a GR-helper and thereby becomes a full-fledged GR-helper. Thus, in accordance with one or more embodiments of the present disclosure, which require one or more extra CSNP(s) be sent out unconditionally, the IS-IS router that is transitioning can continue to act as a GR-helper immediately, without requiring the old active RP module of the IS-IS router to inform the standby RP module that the new active RP module is in the GR helper state. Further, the IS-IS router need not be prompted by the special IIH message with RR to become a helper. Accordingly, if the special IIH messaging with RR flag were to be lost during the transition from the standby mode to active mode, such a condition can be readily tolerated in an example implementation of an IS-IS router embodiment of the present patent disclosure.

In the foregoing Detailed Description, functionalities of the various elements including components/blocks labeled or described as “module” or “process” or “processor” or “controller” or “computer” may be provided through the use of dedicated hardware as well as hardware capable of executing stored or preconfigured software. When provided by a processor, the functions may be provided by a single dedicated processor, by a single shared processor, or by a plurality of individual processors, some of which may be shared or distributed. Moreover, a “processor” or “controller” may include, without limitation, digital signal processor (DSP) hardware, ASIC hardware, read only memory (ROM), random access memory (RAM), and/or other storage media. In a further variation, the NSR and LSP recovery functionality set forth in the foregoing embodiments may be downloaded, uploaded, or otherwise imparted to an existing IS-IS router that does not already have a dedicated module (such as, e.g., the NSR module 320) so as to enhance its performance.

Although various embodiments have been shown and described in detail, the claims are not limited to any particular embodiment or example. None of the above Detailed Description should be read as implying that any particular component, element, step, act, or function is essential such that it must be included in the scope of the claims. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed by the present claims. Accordingly, those skilled in the art will recognize that the exemplary embodiments described herein can be practiced with various modifications and alterations within the spirit and scope of the claims appended below.

What is claimed is:

1. A method performed in a network element operating as an Intermediate System-to-Intermediate System (IS-IS) router having an active route processor (RP) module and a standby route processor (RP) module, the method comprising:
activating the standby RP module to become a new active RP module;
generating at least one Complete Sequence Numbers Protocol Data Unit (CSNP) packet based on information maintained in a link state database associated with the new active RP module; and
transmitting the at least one CSNP packet by the new active RP module on all point-to-point links and all broadcast links identified in an adjacency database of the network element.

2. The method as recited in claim 1, wherein the standby RP module is activated to become the new active RP module upon detecting a failure of the active RP module, the failure comprising at least one of a hardware failure, a software failure and a firmware failure associated with the active RP module.

3. The method as recited in claim 1, wherein the standby RP module is activated to become the new active RP module based on a control signal that is configured to transition the active RP module into a standby mode.

4. The method as recited in claim 1, wherein the at least one CSNP packet is unconditionally transmitted on all point-to-point links and all broadcast links identified in the adjacency database.

5. The method as recited in claim 4, further comprising configuring a timer value for each one of the point-to-point links and the broadcast links identified in the adjacency database and transmitting the at least one CSNP packet upon expiration of the timer value.

6. The method as recited in claim 5, wherein the timer value is configured to be identical for each one of the point-to-point links and the broadcast links identified in the adjacency database.

7. The method as recited in claim 5, wherein the timer value for at least one of the point-to-point links and the broadcast links identified in the adjacency database is configured to be different.

8. The method as recited in claim 1, wherein the link state database comprises a Level 1 (L1) link state database and the at least one CSNP packet is constructed based on information in the L1 link state database.

9. The method as recited in claim 1, wherein the link state database comprises a Level 2 (L2) link state database and the at least one CSNP packet is constructed based on information in the L2 link state database.

10. The method as recited in claim 1, wherein the link state database comprises a Level 1 (L1) link state database and a Level 2 (L2) link state database and one of the at least one CSNP packet is constructed based on information in the L1 link state database and another one of the at least one CSNP packet is constructed based on information in the L2 link state database.

11. The method as recited in claim 1, further comprising:
receiving link state database information from each adjacent IS-IS router to which the at least one CSNP packet has been transmitted; and
updating the link state database associated with the new active RP module based on the received link state database information.

12. The method as recited in claim 1, further comprising inhibiting synchronization of Link State Protocol Data Units (LSPs) between the link state database associated with the new active RP module and a link state database associated with the active RP module.

13. The method as recited in claim 1, further comprising preventing reestablishment of the adjacency database of the network element when a restart request (RR) message is received from a peer IS-IS restarting router, thereby maintaining the adjacency database contents and facilitating the network element to become a Graceful Restart (GR) helper.

14. A network element configured to operate as an Intermediate System-to-Intermediate System (IS-IS) router, comprising:
an active route processor (RP) module associated with an IS-IS routing process based on a first link state database;
a standby route processor (RP) module associated with a second link state database; and
a non-stop routing (NSR) module configured to facilitate, responsive to activating the standby RP module to become a new active RP module upon a failure of the active RP module, generation of at least one Complete Sequence Numbers Protocol Data Unit (CSNP) packet based on information maintained in the second link state database and transmission of the at least one CSNP packet by the new active RP module on all point-to-point links and all broadcast links identified in an adjacency database of the network element.

15. The network element as recited in claim 14, wherein the NSR module is further configured to unconditionally transmit the at least one CSNP packet on all point-to-point links and all broadcast links identified in the adjacency database.

16. The network element as recited in claim 15, wherein the NSR module is further configured to set a timer value for each one of the point-to-point links and the broadcast links identified in the adjacency database and transmitting the at least one CSNP packet upon expiration of the timer value.

17. The network element as recited in claim 14, wherein the NSR module is further configured to inhibit synchronization of Link State Protocol Data Units (LSPs) between the first and second link state databases.

18. The network element as recited in claim 14, wherein the NSR module is further configured to prevent reestablishment of the adjacency database of the network element when a restart request (RR) message is received from a peer IS-IS restarting router, thereby maintaining the adjacency database contents and facilitating the network element to become a Graceful Restart (GR) helper.

19. A non-transitory computer-readable medium containing instructions stored thereon which, when executed by a computer system configured to operate as an Intermediate System-to-Intermediate System (IS-IS) router having an active route processor (RP) module and a standby route processor (RP) module, perform the acts:
activating the standby RP module to become a new active RP module;
generating at least one Complete Sequence Numbers Protocol Data Unit (CSNP) packet based on information maintained in a link state database associated with the new active RP module; and
transmitting the at least one CSNP packet by the new active RP module on all point-to-point links and all broadcast links identified in an adjacency database of the IS-IS router.

20. The non-transitory computer-readable medium as recited in claim 19, further comprising instructions configured to unconditionally transmit the at least one CSNP packet on all point-to-point links and all broadcast links identified in the adjacency database.

21. The non-transitory computer-readable medium as recited in claim 19, further comprising instructions configured to set a timer value for each one of the point-to-point links and the broadcast links identified in the adjacency database and transmitting the at least one CSNP packet upon expiration of the timer value.

22. The non-transitory computer-readable medium as recited in claim 19, further comprising instructions configured to inhibit synchronization of Link State Protocol Data Units (LSPs) between the first and second link state databases.

23. The non-transitory computer-readable medium as recited in claim 19, further comprising instructions configured to prevent reestablishment of the adjacency database of the IS-IS router when a restart request (RR) message is received from an adjacent IS-IS restarting router, thereby maintaining the adjacency database contents and facilitating the IS-IS router to become a Graceful Restart (GR) helper.
